(19) United States
(12) Patent Application Publication
(10) Pub. No.: US 2006/0146996 A1
(43) Pub. Date: Jul. 6, 2006

(54) Text-to-voice system for communicating operational information from a protective device for a power system to a human voice

(76) Inventors: Paul W. Oman, Moscow, ID (US); Edmund O. Schweitzer III, Pullman, WA (US); Jeffrey B. Roberts, Viola, ID (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/332,541

(22) Filed: Jan. 13, 2006

Related U.S. Application Data
(62) Division of application No. 10/273,582, filed on Oct. 18, 2002.

(51) Int. Cl. H04M 11/00

(52) U.S. Cl. 379/88.14

(57) ABSTRACT

The communication system provides audio communication with a user over a phone system of messages and other information originated in non-audio form by a protective device such as a protective relay or the like for an electric power system. The communication system includes a text-to-voice conversion processor responsive to the messages provided by the protective device, and an access control system for establishing phone system communication with a user, including answering incoming telephone calls from the user and initiating dialing-out calls with selected users having telephone numbers known to the communications system. Text material from a protective device is converted to audio and provided to a user, such as a technician for the power system.

### CROSS-REFERENCE TO RELATED APPLICATION

This application is a Divisional application of a U.S. patent application having Ser. No. 10/273,582, entitled Text-to-Voice System for Communicating Operational Information from a Protective Device for a Power System to a Human User, filed Oct. 18, 2002.

### TECHNICAL FIELD

This invention relates generally to communication devices associated with protective devices or systems used for electric power systems, and more specifically concerns an audio communications capability for such protective devices.

### BACKGROUND OF THE INVENTION

Protective devices for electric power systems, such as for example protective relays, recloser controls (relays), sectionalizer controls and circuit breakers, generally referred to as intelligent electronic devices (IEDs), in operation monitor and control electric power systems. A protective relay, for instance, will produce an alarm condition in response to out-of-tolerance conditions on the line, which results in tripping of a circuit breaker. Typically, the relay will produce a text event report, which includes the voltage and current conditions on the line prior to, during and following the abnormal condition, fault location, date and time of occurrence and which phase or phases are involved.

A recloser control in operation attempts to reclose an open circuit breaker. Messages are produced concerning the operation of the device, including information concerning a trip operation. The various information messages/warnings produced by the IEDs are typically transmitted via a communication line to a computer, where the information can be read. However, in many cases, particularly where the IED is remotely located, the customer (such as a night watch or roving operator) will not have access to a computer and therefore has no knowledge that an alarm or an event has occurred involving the IED.

It would be desirable to have a convenient, direct and reliable means to communicate between a protective device and a human user, apart from using a computer, specifically the compatibility for the human user to receive information concerning an alarm or other event produced by the protective device using conventional communication means, such as a telephone line, cellular line or similar means.

### SUMMARY OF THE INVENTION

Accordingly, the present invention is a communications system for a protective device for an electric power system, in which the protective device produces a text message or other signal information which is the result of its protective operation, the communication system comprising: a text-to-voice conversion processor which is responsive to non-audible information, such as a text message, produced by a protective device, which is the result of an operation of the protective device, to produce a corresponding audio message; a communication link connecting the protective device to the text-to-voice conversion processor; an access control system for answering incoming telephone calls to the communication system and for initiating outgoing telephone calls from the communication system to at least one user; and a control processor controlling the operation of the communication system and for providing an audio message through the access control system to a user connected to the communication system.

### BRIEF DESCRIPTION OF THE DRAWINGS

FIG. 1 is a simplified block diagram of the system of the present invention and its operating context.

FIG. 2 is a block diagram of the basic system of the present invention.

FIG. 3 is a function flowchart showing the sequential steps in the dial-in process of the present invention.

FIG. 4 is a function flowchart showing the sequential steps in the automated dial-out process of the present invention.

FIGS. 5-8 are function flowcharts for another embodiment of the present invention, including dial-in, automated dial-out, automated incoming and pass-through access processes.

### BEST MODE FOR CARRYING OUT THE INVENTION

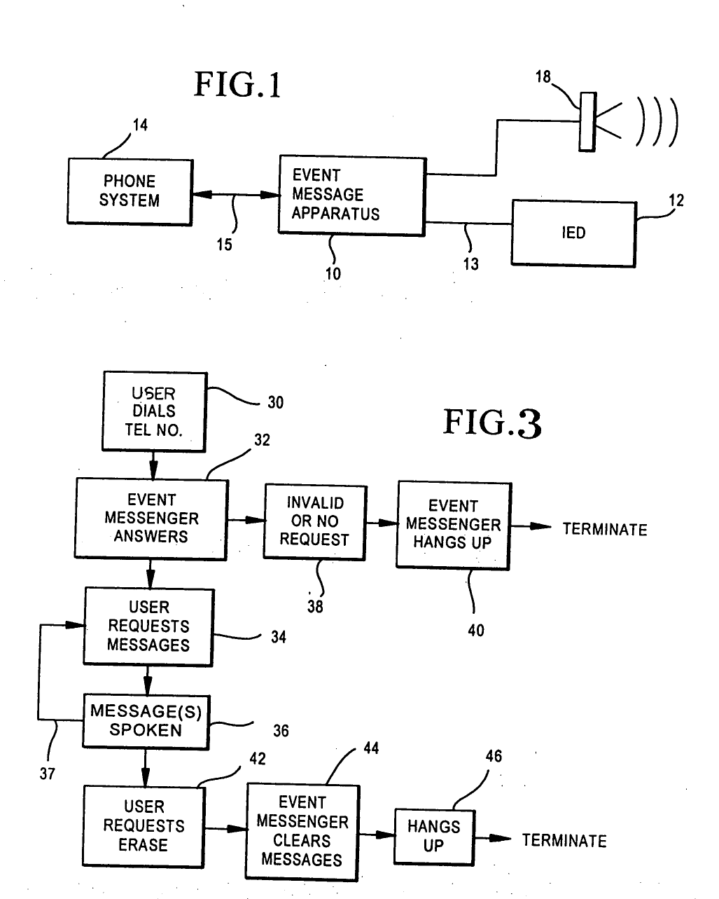

FIG. 1 shows the basic system of the present invention, referred to as an event message apparatus or event messenger, in its operational context. The event message apparatus is shown generally at 10. It is responsive to event information, including alarm information, from an IED, shown generally at 12, such a recloser control (relay), protective relay, circuit breaker or similar device. This transmittal of information typically occurs over an RS-232 line, identified at 13. In another embodiment, the event message apparatus 10 could be connected to a communications processor (not shown), to which a plurality of IEDs is connected. The communications processor generally performs a switching control function between the event messenger and the IEDs. A single event message apparatus 10 thus can serve a number of IEDs through a communication processor, port switch or similar controller.

The user communicates with the event message apparatus by a conventional telephone system 14, including a communication line 15, or cellular link. Communication can be two-way over line 15. Briefly, in the present invention, information in the form of text is communicated from IED 12 to event message apparatus 10, the information being either unsolicited, or requested by the event messenger. The information could be alarms, status or other information obtained by the IED, including circuit breaker status, device temperatures, metering information or apparatus condition, for example. The event message apparatus responds to the text (or numerical) information and converts it to audio information, sending it out over the phone line and through the phone system to the user.

The event messenger also can itself produce an audio alarm, as shown at 18, in response to alarm information from IED 12.

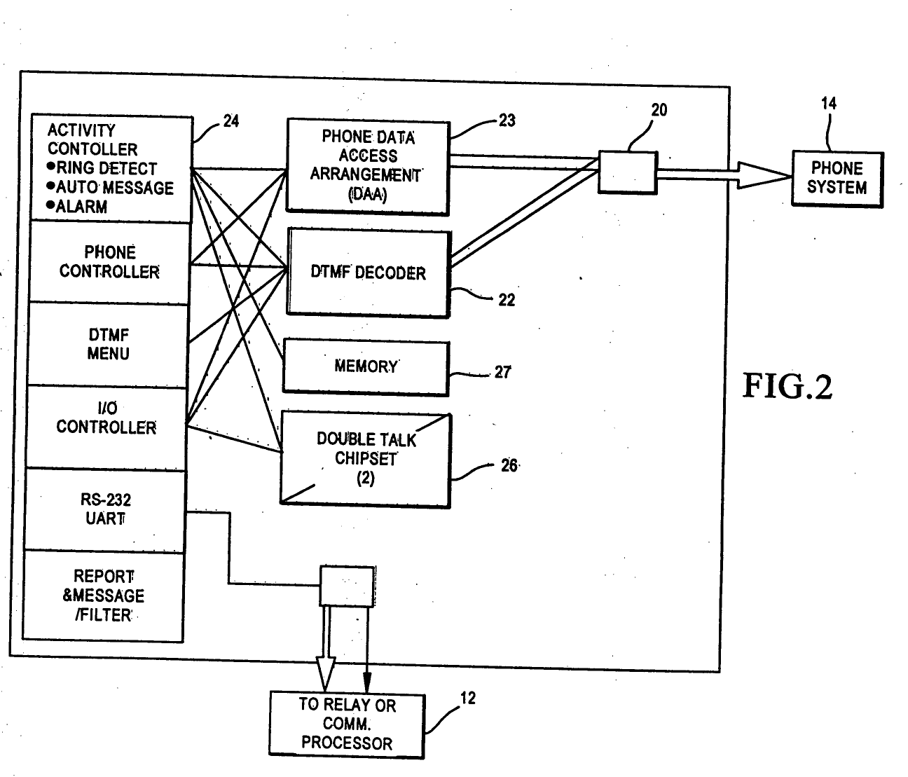

The event message apparatus 10 is shown in more detail in block form in FIG. 2. The phone system is again shown generally at 14, while the IED is again shown at 12. The phone system 14 connects with the event message apparatus 10 through a conventional jack connector/interface 20, at the input to the event message apparatus.

The event message apparatus includes a DTMF (dial tone modulated frequency) decoder 22 and a phone data access arrangement (DAA) device 23. Both of these devices are conventional and can be purchased commercially. They provide an automatic (non-human) capability of connecting the event message apparatus 10 with the user through phone system 14.

The DTMF decoder and the DAA device communicate with a controller 24. The DTMF and DAA devices can be referred to together as an access control system, providing an access/communication interface between the IED and the event messenger 10. Controller 24, which in the embodiment shown is an ATmega 128 or similar device, controls the processing activity of the event messenger, including a variety of specific functions. The embodiment shown, the event messenger is powered from the IED itself at 5.0 volts. The event message apparatus further includes a standard text/voice conversion unit 26, which in the simplest embodiment is capable of producing a voice message from a text or other input from the IED. In a more detailed embodiment, the event message apparatus communicates information requests to the IED, in response to voice instructions from the user over the phone line. The voice message created by the conversion unit from the IED text or other messages is stored in memory 27 in the event messenger 10.

In one operation, the event message apparatus 10 is capable of receiving inquiries from a user over a phone system 14 and line 15 to provide access of the user to stored audio messages, which the user has selected. In another operation, the event message apparatus has the capability of an automatic dial-out procedure over the telephone system to a selected number of users in response to a report or other information from the IED. This information might, for example, include the occurrence of a trip signal or other information, such as messages generated by the IED, the status of alarm contacts determined by the IED and lost or unstable power. Other IED information can be provided.

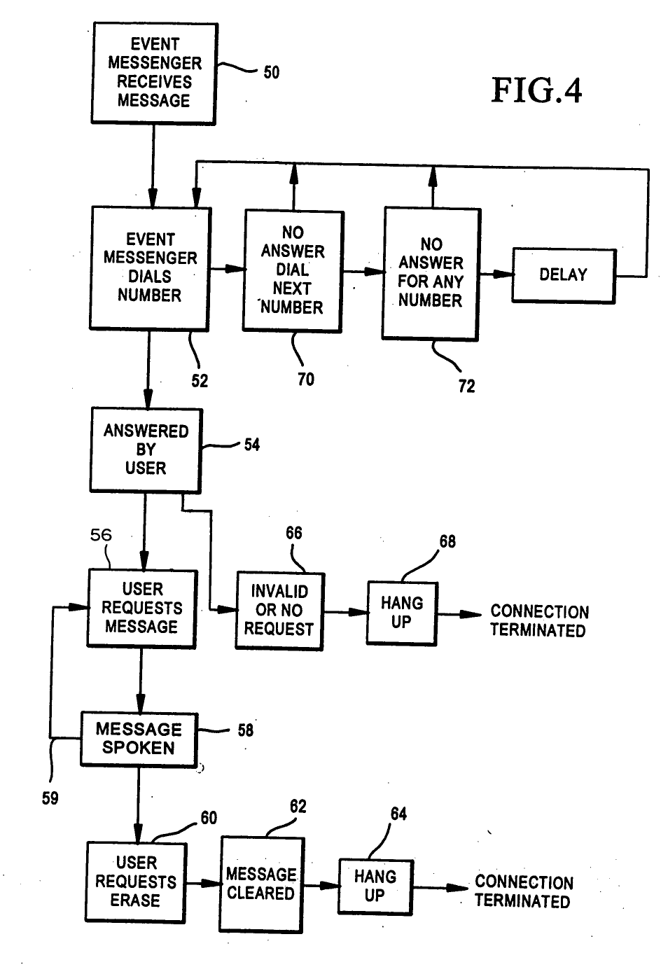

Referring now to FIG. 3 for telephone inquiries, the user in a first step will dial the telephone number associated with the event message apparatus 10, shown at block 30. In a next step, the event message apparatus, using the DTMF decoder and the data arrangement device, answers the call, in effect picking a telephone receiver “off the hook”, and provides a voice message to the user. This is shown at block 32. In the message, the user is requested to press a specific key on the telephone set to listen to any recorded message, which has been stored in the event messenger device. The message or messages have previously been received from the IED or IEDs attached to the event messenger and stored in memory 27.

As indicated above, these messages can encompass a variety of information from the IEDs, including the condition of circuit breakers, specific information, such as event reports from the IEDs, meter data, port status of the IED and status of the various targets on the IED. Other IED information can also be included. This information from the IED, in the form of data, including text, is converted into audio information by the text-to-voice circuit 26, and stored as audio messages in the event messenger memory 27. When the user requests the message to be provided, as indicated at block 34, the message(s) are then spoken by the event messenger and transmitted over the phone system, as set forth in block 36.

If the user either does not respond to or pushes an invalid button (block 38) in response to the prompt by the event message device at block 32, the event messenger will hang up, shown at block 40, terminating the connection.

After the message(s) have been spoken at block 36, the event message apparatus will prompt the user with a message to either erase the message(s), shown at block 42, or re-listen to the message(s), via line 37, by pushing a selected button on the telephone set. If the user requests that the messages can be erased, the event message apparatus will clear the stored messages, shown at block 44, will confirm that the messages have in fact been erased, provide a “good-bye” message, and then hang up, shown at block 46, terminating the connection.

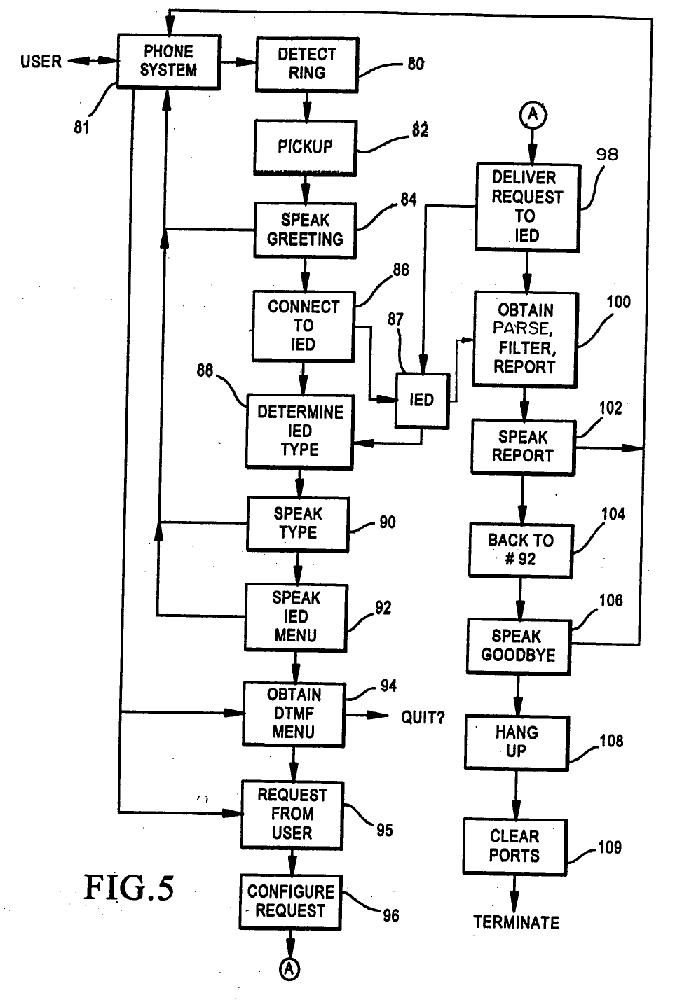

FIG. 4 shows a similar function flowchart for the automated dial-out operation of event messenger 10. In block 50, event message apparatus 10 receives an unsolicited text message from an IED connected thereto through an EIA-32 connection or other communication line. The information in the message can include IED messages, events recorded/executed, alarm contact status, lost/unstable electric power, and relay operations. The event message apparatus then retrieves the first telephone number from its list of users in a telephone directory stored in memory 27 and dials that number, as shown at block 52. If the number is answered, as shown at block 54, an audio message over the phone system is provided to the user, announcing the automated dial-out message system, and requesting the user (answering party) to press a selected button on their telephone set to listen to the message.

If the user requests the message, as shown at block 56, the message is spoken, as shown at block 58. The user then has the option, in response to a prompt from the event messenger 10, of again listening to the message, as shown by line 59, or requesting deletion of the message, as shown at block 60. In response, the event message apparatus clears the stored message, shown at block 62, and then, through the action of the access control system (DTMF and DAA) hangs up, terminating the connection.

Returning to block 54, if the user initially answers the call but thereafter provides an invalid request or provides no request in response to the prompt by the event messenger, as shown at block 66, the event messenger will carry out the hang-up procedure (block 68) and terminate the connection.

In the event that the first number in the phone directory is not answered after that number has been dialed (block 52), the event messenger will dial the next number in the stored user directory, as shown in block 70. This process will continue until there is no answer for any phone number in the directory, as shown at block 72.

In the embodiment shown, the event messenger will make two passes through all of the phone numbers in the directory, attempting to get an answer. The procedure can, of course, vary. In some cases, only one pass through the telephone directory is made, while in other cases, more than two passes are made. At the end of the selected number of passes through the directory, without success, there will be a delay, such as for one hour, which time again may be varied, before redialing can be attempted. In the embodiment shown, if the event messenger 10 receives any new messages with the one-hour time delay period, any remaining delay can be eliminated so that the sequence of calling explained above and shown in FIG. 4 can be initiated immediately.

In the embodiment of FIG. 1, in addition to the dial-in procedure by a user, shown in FIG. 3, and the automated dial-out procedure shown in FIG. 4, the event messenger can provide an audio alarm through audio speaker device 18 in the event that an audio alarm is desired. Typically, the system will include a disable setting for the audio alarm function. In addition, either the dial-in process and/or the automated dial-out process can be disabled if desired.

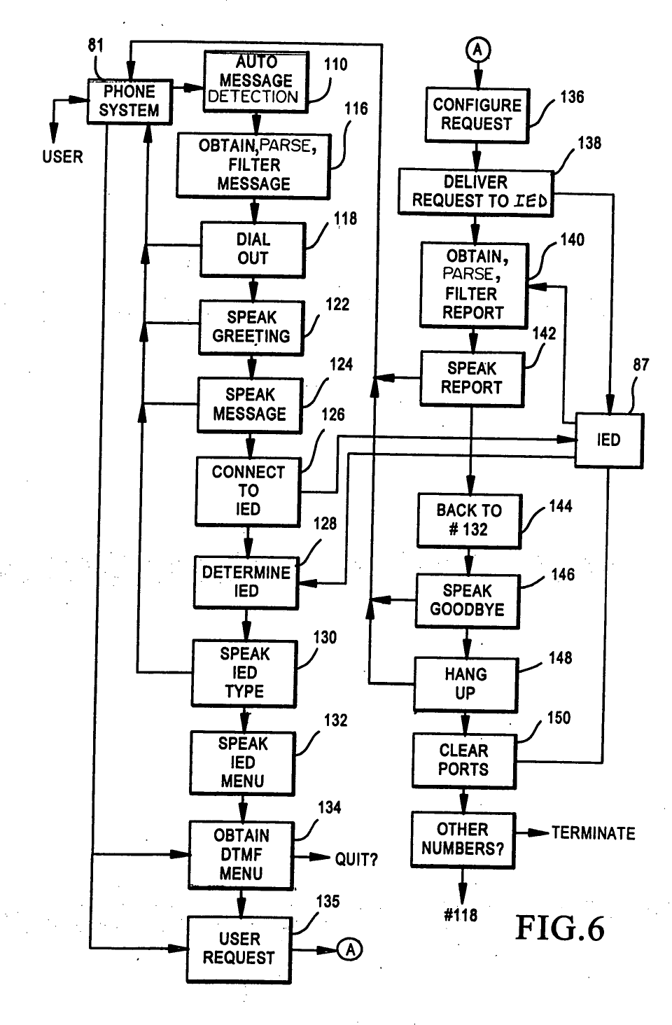

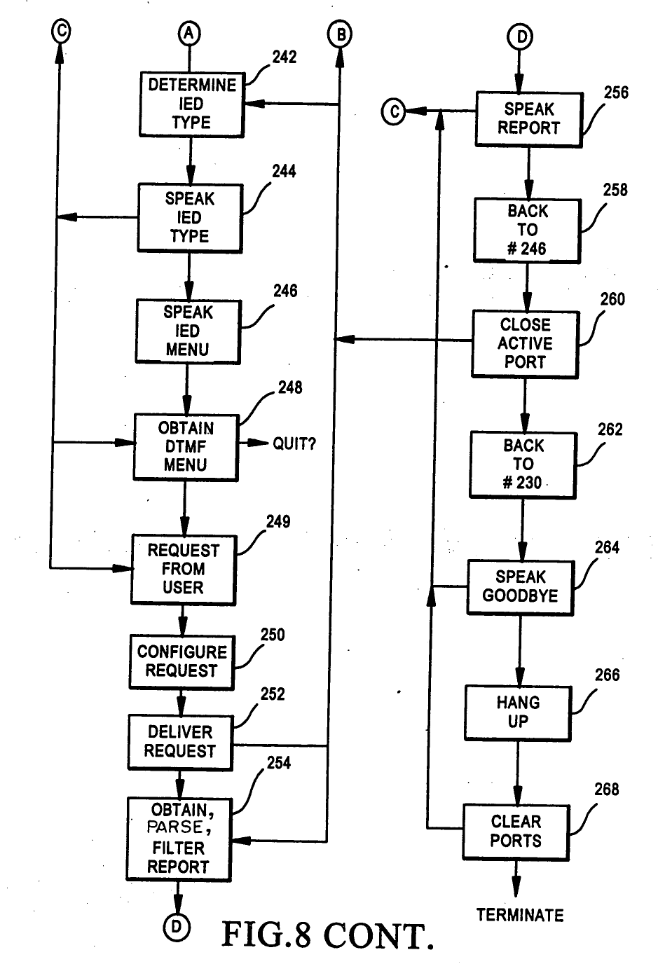

FIGS. 5-8 show another embodiment of the system of the present invention. In this embodiment, real time communication between the IED, the user and the event message apparatus is possible. FIG. 5 shows the remote inquiry process. When the user phones the event message apparatus, using the phone number assigned to the apparatus, the ring produced by the phone system 81 is detected (step 80) and the call “picked up” (step 82) by the operation of the DTMF and the DDA elements (FIG. 2), establishing a conventional phone connection between the user and the event message apparatus. The event message apparatus speaks (verbalizes) an audio greeting (step 84). A connection (step 86) is then made with the IED 87 (such as a protective relay, recloser control, etc.) associated with the event message apparatus. The event message apparatus then determines the identity of the IED (step 88) and speaks that identity to the user (step 90) through the phone system.

The event message apparatus then speaks to the user the menu of possible commands, e.g. requests (step 92), for the various specific information which the IED 87 can supply, e.g. event reports, breaker status, etc. The DTMF menu is then obtained for the particular IED (step 94), which associates a menu selection of the IED and a particular number on the phone set to be operated by the user. Operation of the number will produce a set of tone which identify the selection to the event messenger. The user also has the option to quit at this point, terminating the process.

The specific request of the user is then obtained through the phone connection (step 95), such as by pushing a particular button on a touch-tone phone set. The user's request for the IED 87 is then configured (step 96) and delivered to the IED (step 98). The IED then responds with the desired information, in the form of a report, which is received, parsed and filtered by the event message apparatus, and converted to audio (step 100).

The resulting audio information is then spoken (step 102) back to the user through the phone system 81.

It is also possible in this embodiment for the event message apparatus to receive an unsolicited message from an IED, which undergoes the same processing as step 100, and then is stored in memory 27 (FIG. 2), waiting for an inquiry from a user.

In the next step, the process cycles back to step 92, providing the user the menu again for the IED 87. The process is repeated until the user has no more requests for information. After the user has received all the requested information available from the IED audibly, the event messenger provides a verbal goodbye (step 106) and initiates the hang-up procedure (step 108). Lastly, the ports of the IED are cleared (step 109).

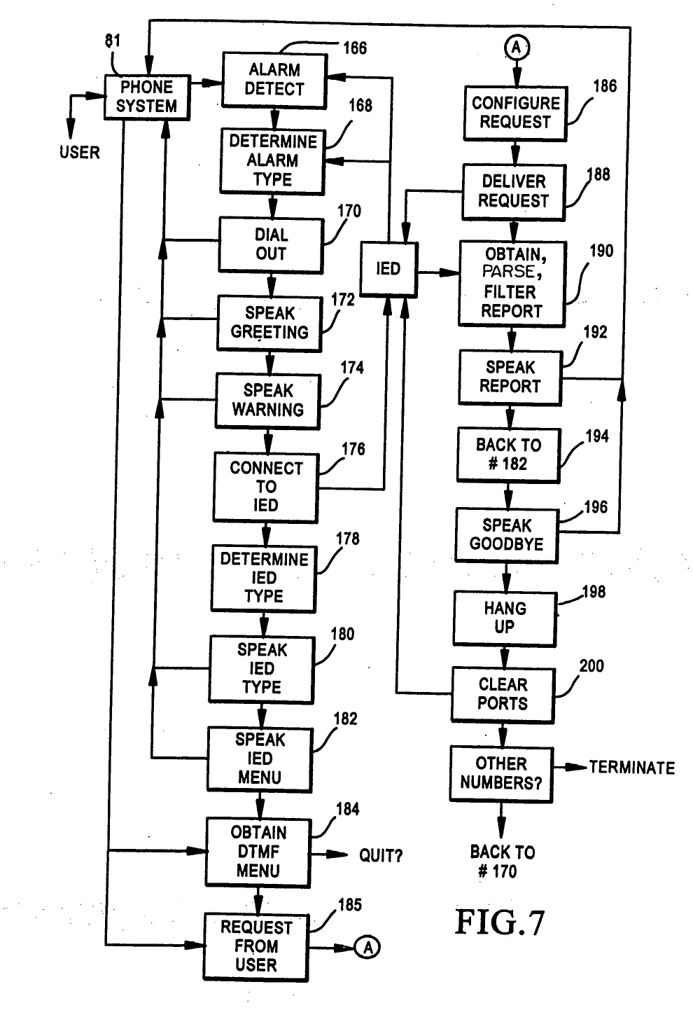

FIG. 6 shows the steps in the automatic dial-out messaging process for the additional embodiment. In step 110, a message from IED 87, which is to be communicated to selected user(s), is detected. The IED provides an indication that the dial-out process is to be used or the event message apparatus itself recognizes that the message is to be transmitted without delay to the user(s). The message is first received, parsed and filtered by the event message apparatus, as shown at step 116, converted to audio and stored. At step 118, the event message apparatus dials out to the first number in its phone directory of users and makes a connection through phone system 81. If the user picks up the phone, the event message apparatus provides a verbal greeting to the user (step 122) and then proceeds to speak the message, at step 124.

In the next step 126, the event message apparatus connects to the IED which originated the message of step 124. The IED type is determined at step 128 and is spoken to the user over the phone system, at step 130. The IED menu, i.e. information that can be requested of the IED, in addition to the original message, is then spoken at step 132, over the phone system. The associated DTMF menu is then obtained from the phone system, at step 134 the user then provides a request at step 135. The request to the IED is configures (step 136) and provided to the IED 87, at step 138.

In response to the user request, the IED provides a report which is received by the event message apparatus, parsed, filtered and converted to audio at step 140. The resulting audio report is then spoken to the user over the phone system, at step 142.

In the next step 144, the user cycles back to the IED menu, which is again spoken to the user, who may select another report. After all the desired reports/information requested by the user from the IED have been received and spoken to the user, a goodbye to the user is spoken through the telephone system at step 146, and the hang-up procedure, through the DTMF and the DDA, is accomplished, at step 148. The ports of the event message apparatus are then cleared, at step 150. If the first number does not answer, or if there are other numbers to be called, the process is repeated, beginning with step 118. When all the numbers to be called are completed, the process is terminated.

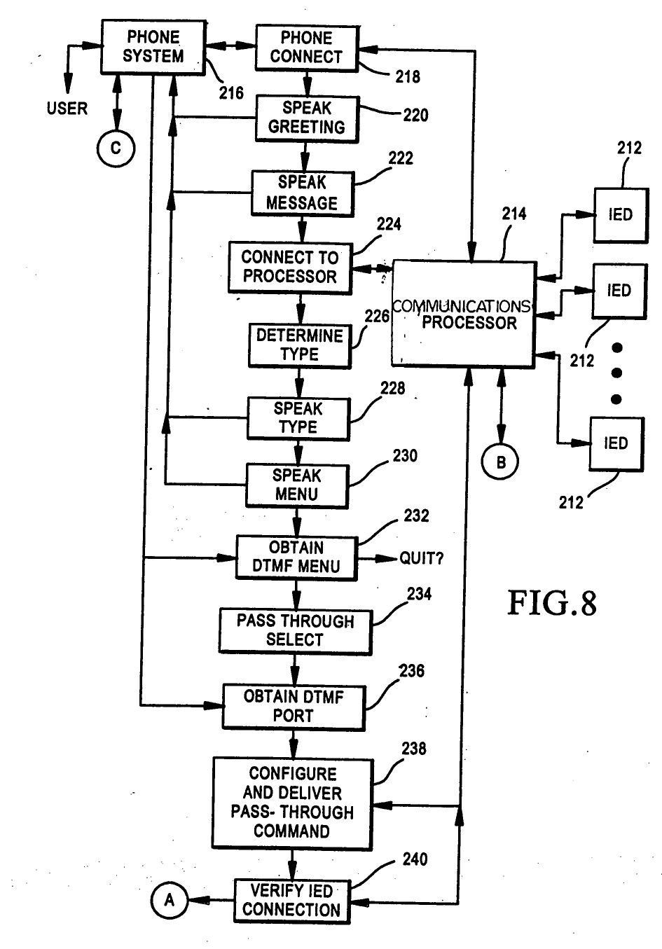

FIG. 7 shows the operation of the system for an automated warning. The event message apparatus is shown associated with IED 87 and is accessible by phone system 81. In a first step at 166, an alarm condition from IED 87 is detected. In the next step 168, the alarm type is determined and the warning is configured is audible form. In the next step, 170, the event message apparatus dials out through the phone system 81 and makes a connection with a desired user. After a connection is made, a greeting to the user is spoken at step 172 and the audible warning is then provided to the user, at step 174.

The event message apparatus then makes a connection with the IED 87, at step 176. In the next step 178, the IED is identified and the event message apparatus speaks the IED type to the user over the phone system. The menu for the IED is then spoken to the user and the DTMF menu is obtained from the IED from the phone system, at step 184. Alternatively, the user may quit at this point.

The user then provides a request from the IED menu, at step 185.

At step 186, the IED request is configured and then delivered to the IED, at step 188. n response, the IED send the desired information (report) at step 190, which is received parsed and filtered to produce a corresponding audio report. At step 192, the report is spoken to the user through the phone system.

At step 194, the user may again hear the IED menu and make a further selection. At the end of all the audible report possibilities, the event message apparatus verbalizes an audio goodbye at step 196 and initiates a hang-up procedure at step 198. The IED ports are then cleared, at step 200. At this point, the event message apparatus ascertains whether there are other numbers to call with the warning. If there are, then the event messenger cycles back to step 170. If not, the process is terminated.

Lastly, the other embodiment of FIGS. 5-8 includes a “pass-through” access process, in which the event message apparatus is connected to a plurality of IEDs 212-212 through an communication processor 214, which is capable of supporting a plurality of IEDs. The event message apparatus has access to the user and vice versa through the phone system 216. The user can initiate a phone connection to the event message apparatus, or the event message apparatus can initiate contact to a user through the phone system, including an automatic warning routine.

If a connection is made (step 218) an audio greeting is spoken to the user over the phone system and a message or warning (if any) is provided audibly to the user, as shown at step 222. The event messenger is then connected to a communication processor 214, which is identified according to type at step 226. The type of communication processor 214 is then spoken to the user over the phone system 216 at step 228; and the menu for the communication processor is then provided to the user, at step 230. At step 232, the DTMF menu is then obtained for the communication processor from the phone system. Alternatively, the user may quit the process at this point.

The pass-through command is then selected by the event messenger at step 234 and the DTMF pass-through port number is obtained from the phone system, at step 236. The pass-through command is then configured and delivered, at step 238. The connection to the desired IED through the communications processor is then verified, at step 240.

The connected IED is then identified and spoken at step 244 to the user over the phone system 216. The menu for the one connected IED is then spoken to the user over the phone system at step 246, and the DTMF menu for the IED is obtained at step 248. Alternatively, the user can quit at this point. At step 250, a request command for information from the IED is configured in accordance with the user's request from the IED menu, steps 249 and 250, and the command is delivered to the IED through the communication processor, at step 252.

In response, a report from the IED is provided back to the event message apparatus, through the communications processor 214. The apparatus received the message, parses, filters and configures the message in audio form, at step 254. The report is then spoken to the user over the phone system at step 256. At the end of this first report, the process cycles back to the menu for the connected IED (step 246). The user is then free to select another report from the menu. After all the desired reports from a particular IED are obtained, the active port is closed, at step 260.

The next IED (including another IED requested by the user) is then connected through the communications processor and the process cycles back to step 230. When all the desired IEDs have been connected, a goodbye is spoken, at step 264. The hang-up procedure is carried out at 266. The ports of the event message apparatus are then cleared at step 268.

Accordingly, a system has been described which is used in conjunction with a protective device used for electric power systems, the system converting a text report, warning or other message received from the protective device to audio. The system provides the audio message to a user in response to a telephone inquiry over conventional phone lines, or itself carries out an automatic dial-out process, connecting it to various users in its directory. Messages, warnings and other information originated by a protective device for the electric power system can be provided audibly to the user concerning the electric power system, without the use of a computer.

In a variation of both of the above embodiments, the voice message apparatus can be set up to permit the user to select and/or configure custom command/request sets for the event messenger, adapted for the specific features of a particular IED. This provides flexibility for both the voice interaction with the event messenger and the form of the request to the IED.

Although a preferred embodiment of the invention has been described for purposes of illustration, it should be understood that various changes, modifications and substitutions might be incorporated in the embodiment without departing from the spirit of the invention, which is defined in the claims, which follow. For instance, while telephone lines and cellular communication have been described, other types of telephonic (voice) communication can be used for communicating between the user and the communications device.

What is claimed:

1-13. (canceled)

14. A method of notifying a power system maintenance person about power system events comprising:
a. storing power system event information in an Event Messenger Apparatus;
b. establishing a vocal communications channel between the Event Messenger Apparatus and the power system maintenance person; and
c. vocally communicating the stored power system event information to the power system maintenance person.

15. The method of claim 14, further comprising the step of deleting the stored event data corresponding to the communicated vocal event information from the Event Messenger Apparatus.

16. The method of claim 14, further comprising the steps of:
a. maintaining a list of power system maintenance personnel in the Event Messenger Apparatus;
b. selecting the first power system maintenance person on the list of power system maintenance personnel; and
c. attempting to establish a vocal communications channel between the Event Messenger Apparatus and the selected power system maintenance person, and if unsuccessful, selecting the next power system maintenance person on the list of power system maintenance personnel and repeating this step, until either a vocal communications channel is established between the Event Messenger Apparatus and a power system maintenance person, or the Event Messenger Apparatus has attempted to establish a vocal communications channel with every power system maintenance person on the list of power system maintenance personnel.

17. The method of claim 16, further comprising the step of waiting a predetermined time after failing to establish a vocal communications channel between the Event Messenger Apparatus and a power system maintenance person on the list of power system maintenance personnel, and then repeating the process of attempting to establish a vocal communications channel between the Event Messenger Apparatus and a power system maintenance person on the list of power system maintenance personnel.

18. The method of claim 16, further comprising the steps of:
a. storing the occurrence of power system events from a plurality of Intelligent Electronic Devices;
b. presenting the power system maintenance person with a menu in vocal form comprised of the different Intelligent Electronic Devices monitored by the Event Message Apparatus;
c. selecting an Intelligent Electronic Device from the menu; and
d. vocally communicating the stored power system events corresponding to the selected Intelligent Electronic Device to the power system maintenance person.

19. The method of claim 16, further comprising the steps of:
a. presenting the power system maintenance person with a menu in vocal form comprised of different types of information about the selected Intelligent Electronic Device;
b. selecting a type of information about the selected Intelligent Electronic Device from the menu; and
c. vocally communicating the selected type of information about the selected Intelligent Electronic Device to the power system maintenance person.

20. A method for a power system maintenance person to retrieve information concerning an Intelligent Electronic Device comprising:
a. establishing a vocal communications channel between the power system maintenance person and an Event Messenger Apparatus;
b. establishing a communications channel between the Event Messenger Apparatus and the Intelligent Electronic Device;
c. presenting the power system maintenance person with a menu in vocal form comprised of different types of information about the Intelligent Electronic Device;
d. selecting a type of information about the Intelligent Electronic Device from the menu; and
e. vocally communicating the selected type of information about the Intelligent Electronic Device to the power system maintenance person.

21. The method of claim 20, further comprising the steps of:
a. presenting the power system maintenance person with a second menu in vocal form comprised of the different Intelligent Electronic Devices monitored by the Event Message Apparatus; and
b. selecting an Intelligent Electronic Device from the second menu.

22. A system for notifying a power system maintenance person about power system events comprising:
a. means for storing power system event information in an Event Messenger Apparatus;
b. means for establishing a vocal communications channel between the Event Messenger Apparatus and the power system maintenance person; and
c. means for vocally communicating the stored power system event information to the power system maintenance person.

23. The system of claim 22, further comprising means for deleting the stored event data corresponding to the communicated vocal event information from the Event Messenger Apparatus.

24. The system of claim 22, further comprising:
a. means for storing the occurrence of power system events from a plurality of Intelligent Electronic Devices;
b. means for presenting the power system maintenance person with a menu in vocal form comprised of the different Intelligent Electronic Devices monitored by the Event Message Apparatus;
c. means for selecting an Intelligent Electronic Device from the menu; and
d. means for vocally communicating the stored power system events corresponding to the selected Intelligent Electronic Device to the power system maintenance person.

25. The system of claim 22, further comprising:
a. means for presenting the power system maintenance person with a menu in vocal form comprised of different types of information about the selected Intelligent Electronic Device;
b. means for selecting a type of information about the selected Intelligent Electronic Device from the menu; and
c. means for vocally communicating the selected type of information about the selected Intelligent Electronic Device to the power system maintenance person.

26. A system that allows a power system maintenance person to retrieve information concerning an Intelligent Electronic Device comprising:
a. means for establishing a vocal communications channel between the power system maintenance person and an Event Messenger Apparatus;
b. means for establishing a communications channel between the Event Messenger Apparatus and the Intelligent Electronic Device;
c. means for presenting the power system maintenance person with a menu in vocal form comprised of different types of information about the Intelligent Electronic Device;
d. means for selecting a type of information about the Intelligent Electronic Device from the menu; and
e. means for vocally communicating the selected type of information about the Intelligent Electronic Device to the power system maintenance person.

27. The system of claim 26, further comprising:
f. means for presenting the power system maintenance person with a second menu in vocal form comprised of the different Intelligent Electronic Devices monitored by the Event Message Apparatus; and
g. means for selecting an Intelligent Electronic Device from the second menu.
